(19) United States
(12) Patent Application Publication
(10) Pub. No.: US 2012/0070541 A1
(43) Pub. Date: Mar. 22, 2012

(54) SYRUP AND SUGAR PREPARED FROM MAPLE SAP OR MAPLE SYRUP AND PROCESS FOR PREPARATION THEREOF

(75) Inventors: Nam Fong HAN, Ottawa (CA); Wei ZOU, Ottawa (CA); Binjun ZHAO, Ottawa (CA); Lloyd Perry FLEMING, Ottawa (CA); Zhizhong DUAN, Ottawa (CA)

(73) Assignee: NATIONAL RESEARCH COUNCIL OF CANADA, Ottawa (CA)

(21) Appl. No.: 13/236,089

(22) Filed: Sep. 19, 2011

Related U.S. Application Data
(60) Provisional application No. 61/384,497, filed on Sep. 20, 2010.

(51) Int. Cl. A23L 1/09; A23L 1/304; A23L 1/30

(52) U.S. Cl. 426/74; 426/48; 426/658; 426/648

(57) ABSTRACT

Natural maple saps and maple syrups are contacted with an immobilized isomaltulose-forming microorganism to convert at least 20% of the sucrose contained in the sap or syrup to isomaltulose. The microorganism may be immobilized on calcium alginate and prepared as a column through which sap or syrup flows. The resultant isomaltulose-containing solutions are concentrated to produce reduced or low glycemic index sugar syrups, semi-solid and solid sugar products.

### CROSS REFERENCE TO RELATED APPLICATIONS

The present application claims the benefit of U.S. Provisional Application 61/384,497, filed Sep. 20, 2010, which is incorporated herein by reference in its entirety.

### FIELD

The present disclosure relates generally to edible products based on maple syrup or maple sap.

### BACKGROUND

Isomaltulose (6-O-α-D-glucopyranosyl-D-fructose) is a reducing disaccharide which is otherwise known as palatinose. Isomaltulose is a natural constituent presented in small amount in honey and sugar cane with a low glycemic index of 32 (see David Mendosa, Revised International Table of Glycemic Index (GI) and Glycemic Load (GL) Values—2008, http://www.mendosa.com/gilists.htm). Isomaltulose has a very natural sweet taste.

The glycemic index (GI) is a measure of the effects of carbohydrate on blood sugar levels. Carbohydrates that break down quickly during digestion and release glucose rapidly into the bloodstream have a high GI. Carbohydrates that break down more slowly, releasing glucose more gradually into the bloodstream, have a low GI. The current validated methods of determining GI use glucose as the reference food, given it has a GI value of 100 by definition. A GI of 70 or more is high, a GI of 56 to 69 inclusive is medium, and a GI of 55 or less is low.

The theoretical glycemic index of a mixture of carbohydrate can be calculated based on the weighted average of the glycemic indexes of all the carbohydrates in the mixture. For example: 100% sucrose has a GI of 64 and 100% isomaltulose has a GI of 32. Therefore, a mixture of 70% sucrose and 30% isomaltulose has a theoretical GI of 54.4.

Isomaltulose is digested slowly but completely in small intestine. As a result the glucose enters the blood at a slow rate, avoiding high peaks and sudden drops in glucose levels and therefore insulin levels as well. This leads to a more balanced and prolonged energy supply in the form of glucose.

Isomaltulose also supports improved fat oxidation during physical activity as high insulin levels hinder the use of lipids as an energy source. As such, isomaltulose can increase the amount of fat used as energy, thus enhancing performance endurance.

Isomaltulose has been produced from sucrose on an industrial scale using microorganisms, which may optionally be immobilized microorganisms.

German Pat. No. 1 049 800 discloses that sucrose is converted into isomaltulose by enzymes of microbial origin. In addition to Protaminobacter rubrum, other bacteria such as Erwinia carotovora, Serratia marcescens, Serratia plymuthica and Leuconostoc mesenteroides are also used for conversion of sucrose into isomaltulose (S. Schmidt-Berg-Lorenz, W. Mauch, ZEITSCHRIFT FUER DIE ZUCKERINDUSTRIE, 1964, 14, 625-627; F. H. Stodola, 126th Meeting of Amer. Chem. Soc. Sept., 1954, Abstracts of papers, p. 5D; W. Mauch, S. Schmidt-Berg-Lorenz, ZEITSCHRIFT FUER DIE ZUCKERINDUSTRIE, 1964, 14, 309-315; W. Mauch, S. Schmidt-Berg-Lorenz, ZEITSCHRIFT FUER DIE ZUCKERINDUSTRIE, 1964, 14, 375-383).

German Pat. No. 2 217 628 and German Offenlegungsschrift No. 2 806 216 further disclose that the enzymatic conversion of sucrose into isomaltulose can be carried out continuously or batch-wise by a culture of isomaltulose-forming microorganisms in the presence of sucrose.

U.S. Pat. No. 4,359,531 (1982) discloses that isomaltulose can be produced by contacting a pure sucrose solution, preferably above 30% concentration, with an isomaltulose-forming microorganism genus Erwinia immobilized on calcium alginate and other materials (also see: P. S. J. Cheetham, C. Garrett, J. Clark, Isomaltulose production using immobilized cells, Biotechnology and Bioengineering, 1985, Vol. XXVII, 471-481).

U.S. Pat. No. 4,640,894 (1987) discloses that isomaltulose can be produced by passing a pure sucrose solution, preferably at 45 to 75% concentration, through a reactor containing dead, immobilized cells of an isomaltulose-forming microorganism. Impure sucrose solutions, for example up to 15% v/v of molasses, may also be used but the process produced relatively impure isomaltulose.

P. de Oliva-Neto and Paula T. P. Menão disclose that isomaltulose can be produced by contacting sucrose with Protaminobacter rubrum immobilized in calcium alginate (see P. de Oliva-Neto and Paula T.P. Menão, Isomaltulose production from sucrose by Protaminobacter rubrum immobilized in calcium alginate, Bioresource Technology 100 (2009) 4252-4256).

H. Kawaguti and others teach that isomaltulose can be produced from sucrose using the enzyme glycosyltransferase, which can be produced using Erwinia sp. D12. Isomaltulose production from sucrose was performed using free Erwinia sp. D12 cells (see H. Y. Kawaguti et al., Isomaltulose production using free cells: optimisation of a culture medium containing agricultural wastes and conversion in repeated-batch processes, J. Ind. Microbiol. Biotechnol. (2007) 34:261-269).

E.S. Sharpe and others disclose the production of isomaltulose using sucrose and enzyme preparations from the bacterium Leuconostoc mesenteroides (NRRL B-512F) (see E. S. Sharpe et al., Formation of Isomaltulose in Enzymatic Dextran Synethsis, J. Org. Chem., 1960, 25(6), pp 1062-1063).

The above-described processes attempt to achieve maximum conversion of sucrose into isomaltulose. High concentrations of sucrose are often used in an effort to achieve maximum conversion, and isomaltulose product is generally obtained in crystals.

It is, therefore, desirable to provide a process whereby less concentrated sucrose-containing solutions may be utilized to achieve conversion of sucrose into isomaltulose.

### SUMMARY

The present disclosure provides a process that can obviate or mitigate at least one disadvantage of previous processes for converting sucrose to isomaltulose. For example, in one aspect, the present disclosure provides a process that converts sucrose to isomaltulose that does not significantly alter the non-sucrose components in the maple sap or maple syrup.

Described herein is a process for conversion of sucrose in maple sap or maple syrup into isomaltulose. Although sucrose is the most prevalent sugar in maple sap and maple syrup, there has been no report on the use of maple sap and syrup for isomaltulose production, or the preparation of syrup-based or sugar-based products thereafter.

A process for the production of isomaltulose-containing sugar solutions, sugar syrups, semi-solid sugars and sugar powders is described. The process comprises enzymatic conversion of maple saps and maple sugars to produce edible products such as sugar solutions, sugar syrups, semi-solid sugars and sugar powders.

According to one aspect of the application, a process for the conversion of 20% or more of sucrose in maple sap or maple syrup to isomaltulose is described. The process includes contacting the sap or syrup with at least one immobilized isomaltulose-forming microorganism.

The isomaltulose-forming microorganism may be immobilized on a column of calcium alginate. The at least one microorganism may be Erwinia Rhapontici (NCPPB 1578), Protaminobacter rubrum (CBS 574.77), or a combination thereof. The maple sap may include a sucrose-containing solution from a maple tree. The sucrose-containing solution may be concentrated by a reverse-osmosis process. The maple syrup may include a concentrated solution from maple sap produced by a boiler, which solution comprises from about 8% to about 50% sucrose. The maple sap or maple syrup may include at least one phenolic compound, where the composition of the at least one phenolic compound in the maple sap or maple syrup remains unchanged. The maple sap or maple syrup may include at least one mineral where the composition of the mineral in the maple sap or maple syrup remains unchanged. The at least one mineral may be magnesium, manganese, potassium, calcium, zinc, iron, or any combination thereof.

According to another aspect of the application, a product derived from maple syrup or maple sap is described. The product includes at least 20 wt % of sugars as isomaltulose.

The product may include between 20 wt % and 65 wt % of sugars as isomaltulose. The product may further include one or more additional sugar, such as sucrose. The product may be a solution, a syrup, a semi-solid or a solid. The product may further include at least one phenolic compound. The product may further include at least one mineral, such as magnesium, manganese, potassium, calcium, zinc, iron, or any combination thereof. The HPLC analysis of the product may yield an HPLC profile substantially identical to FIG. 2B.

Advantageously, it has been found that it is possible to convert sucrose in maple sap and maple syrup, at least in part and typically about 20-80% by weight of the sucrose content, to isomaltulose. This conversion can be done by means of immobilized cells of isomaltulose-forming microorganisms, for instance, Erwinia Rhapontici (NCPPB 1578) and Protaminobacter rubrum (CBS 574.77). The resultant solutions can be used directly as a final product, or as ingredients in maple-based products when further processed to sugar syrup, or to a semi-solid or solid sugar product. Because such products are lower in sucrose content, these products will have a lower glycemic index than the counterpart product based on maple sap or syrup.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures.

FIG. 1 is a Flow chart representing an embodiment of the process described herein.

FIG. 2A is an HPLC trace of eluent of ethyl acetate extracts from maple sap with no sucrose to isomaltulose conversion, detected at 214 nm.

FIG. 2B is an HPLC trace of eluent of ethyl acetate extracts from maple sap with sucrose to isomaltulose converted according to an embodiment of the process described herein, detected at 214 nm.

### DETAILED DESCRIPTION

One source of sucrose is maple sap or maple syrup. Generally, the present disclosure provides a method and system for the conversion of sucrose in maple sap or maple syrup to isomaltulose.

The process for conversion of sucrose to isomaltulose in maple sap or maple syrup may be carried out by continuously passing maple sap or maple syrup, comprising a sucrose concentration of 2% to 55% (w/w), preferably 8 to 50% (w/w), and at ambient temperature, preferably at 20-30° C., through a reactor containing immobilized isomaltulose-forming cells.

As indicated, the starting product or starting material for the process of the present invention may be maple sap or maple syrup. Maple sap is a naturally-occurring, clear liquid that may be obtained from sugar-maple trees using methods known to those of skill in the art. It is a sweet solution comprising between about 1 to 3% sugars, predominantly sucrose; maple sap may also comprise traces of other sugars such as glucose or fructose, nitrogenous and/or phenolic compounds, organic acids, as well as different minerals (Morselli M F, Whalen M L. (1996) Maple chemistry and quality. In: Koelling M R and Heiligmann R B editors. North American maple syrup producers manual. Columbus: The Ohio State University. p 162-171). Maple syrup is obtained from maple sap using methods known to the skilled artisan, most often by concentration of maple sap by a boiler or other appropriate methods.

If desired, the starting material can be used directly in the process of the present invention, without further refinement. Alternatively, maple sap can be concentrated by an appropriate process, such as by a reverse osmosis process, from natural maple sap. In another alternative, the maple sap or maple syrup starting product may be filtered prior to use in the process of the present invention.

The starting material may comprise sucrose in a concentration of about 2% to about 55% (w/w). For example, and without wishing to be limiting in any manner, the maple sap or maple syrup starting material may comprise a sucrose concentration of about 2, 3, 4, 5, 6, 7, 8, 9, 10, 15, 20, 25, 30, 35, 40, 45, 50, or 55% (w/w), or any value therebetween, or any range defined by any two values just recited. In one example, the sucrose concentration in the starting product may be about 8-50% (w/w); in various other examples, the concentration of sucrose in the starting product may be 10, 25, or 50% (w/w).

As described above, sucrose is the predominant sugar in maple sap and maple syrup. As such, sucrose may constitute 100% or less of the sugars in the maple sap or maple syrup starting product. More specifically, and without wishing to be limiting in any manner, sucrose may represent about 90% to about 100% (w/w) of the sugars in maple sap or maple syrup; for example, sucrose may comprise about 90, 91, 92, 93, 94, 95, 96, 97, 98, 99, or 100% (w/w) of sugars in maple sap/syrup, or any amount therebetween. For the purpose of simplicity, the percentage of sugars (w/w) in the starting material and in the product will not take into account any possible trace levels of sugars other than sucrose and isomaltulose (though their presence therein is acknowledged).

The process of the present invention may be performed at ambient temperature. Generally, the ambient temperature may be a temperature at which the isomaltulose-forming cells are active and allows proper functioning of the reactor. Ambient temperature may be between about 20 and 30° C.; for example, the temperature at which the process is performed may be 20, 21, 22, 23, 24, 25, 26, 27, 28, 29, or 30° C., or any temperature therebetween, or any range defined by any two values just recited. In a specific, non-limiting example, the process may be performed at room temperature, which is typically defined in the art to be between about 20° C. and 25° C.

The term “isomaltulose-forming cells”, also referred to as “isomaltulose-forming microorganisms”, refers to microbes capable of converting sucrose to isomaltulose. Any suitable microbe known in the art may be used in the present process. Examples of isomaltulose-forming microorganisms include, but are not limited to Erwinia Rhapontici (NCPPB 1578) and Protaminobacter rubrum (CBS 574.77).

The isomaltulose-forming cells may be immobilized on any suitable medium allowing full activity of the cells. Without wishing to be limiting in any manner, the cells may be immobilized on an inert support such as a bead (Sepharose, cellulose, magnetic nanoparticle), a membrane (cellulose, PVDF), or a suitable surface (plastic, glass, stainless steel); via entrapment in a gel (calcium alginate, agar, polyacrylamide); or via cross-linking to form aggregates. In a specific, non-limiting example, the cells may be immobilized on calcium alginate.

The conversion of sucrose in maple sap and maple syrup by means of immobilized isomaltulose-forming cells, for instance, Erwinia Rhapontici (NCPPB 1578) and Protaminobacter rubrum (CBS 574.77), can be carried out in a reactor either continuously or batch-wise. The reactor may be any bioreactor known in the art and suitable for adaptation to the process of the present invention. For example, and without wishing to be limiting, the reactor may be a column comprising immobilized isomaltulose-forming cells; such a column may be straight or coiled, in a vertical or horizontal orientation, and may operate under pressure or by gravity. Alternatively, the bioreactor may comprise a vessel in which the immobilized isomaltulose-forming cells are contacted with the starting product, and may also comprise a means for stirring the mixture and a means for separating the product from the immobilized cells.

The conversion rate of sucrose into isomaltulose may depend on the size or length of the reactor in the particular embodiment envisaged. The conversion rate may additionally be influenced by flow rate through or reaction time in such a reactor, and by the concentration of maple sap or maple syrup. Therefore, the desired extent of conversion of sucrose to isomaltulose can be achieved, depending on the pre-determined conversion selected for a given product. The conversion rate can be set to correspond with the desirable glycemic index value of the resulting product.

The isomaltulose-containing product produced by the process as described herein may be a solution, a syrup, a semi-solid, or a solid; the product may also be a powder, obtained by grinding the solid product, or by spray-drying the solution or syrup. The isomaltulose-containing product may comprise a mixture of sucrose and isomaltulose in varying amounts. Isomaltulose may be present in the product at a level of at least about 20% of sugars. More specifically, and without wishing to be limiting in any manner, the product may comprise isomaltulose at a level of between about 20 and about 65%; for example, the product may comprise isomaltulose at a level of about 20, 25, 30, 25, 40, 45, 50, 55, 60, or 65% of sugars, or any value therebetween, or any range defined by any two values just described.

Isomaltulose-containing solutions obtained from maple sap and maple syrup can be concentrated to syrup containing 67% sugars (sucrose plus isomaltulose). In one example, isomaltulose-containing solutions obtained from maple sap and maple syrup can be concentrated to form a syrup containing 67% sugars (sucrose plus isomaltulose) with a level of about 20% isomaltulose. Such an exemplary product has a lower glycemic index than natural maple syrup.

In a further example, a process is described in which an isomaltulose-containing solution is obtained from maple sap and maple syrup, which can be concentrated and optionally processed into a semi-solid product containing 67% sugars (sucrose plus isomaltulose) with 30% or more isomaltulose by weight, with reduced glycemic index.

Further, an isomaltulose-containing solution obtained from maple sap or maple syrup can be processed to produce a solid product containing at least 85% sugars (sucrose plus isomaltulose) with 30% or more isomaltulose by weight, with reduced glycemic index.

The isomaltulose-containing products obtained from maple sap and maple syrup may optionally be sterilized prior to use.

Apart from the sucrose content, maple sap or maple syrup contains other components, such as complex polyphenoles, oligosaccharides, amino acids, phytohormones, and minerals. Polyphenolic compounds may act as antioxidants and may provide antiradical and antimutagenic health benefits (Ball, J. Chem. Edu. 2007, 84, 1647-1650; Li and Seeram, J. Functional Foods, 2011, 3, 125-128; J. Agric. Food Chem. 2010, 58, 11673-11679; Theriault, Caillet, Kermasha and Lacroix, Food Chemstry, 2006, 98, 490-501). The maple sap or maple syrup may comprise at least one phenolic compound and the process of conversion of sucrose to isomaltulose may result in the composition of the at least one phenolic compound in the maple sap or maple syrup remaining unchanged.

The maple sap or maple syrup may comprise at least one mineral and the process of conversion of sucrose to isomaltulose may result in the composition of the at least one mineral in the maple sap or maple syrup remaining unchanged. The at least one mineral may be magnesium, manganese, potassium, calcium, zinc, iron, or any combination thereof

Products may be formed from maple saps or syrups converted according to the process described herein. Such products may be used as ingredients or flavor agents in food or beverage formulations. For example, and without wishing to be limiting, isomaltulose-containing solutions obtained by the process of the present invention may be included in soft drinks or sports drinks. In other non-limiting examples, isomaltulose-containing syrups, semi-solids, or solids can be used in maple butter, maple jelly, or maple candy. In yet another application, isomaltulose-containing solutions or syrups may be used to produce syrups analogous to, or a replacement for, maple syrup. The isomaltulose-containing products of the present invention may provide reduced- or low-glycemic index health food ingredients.

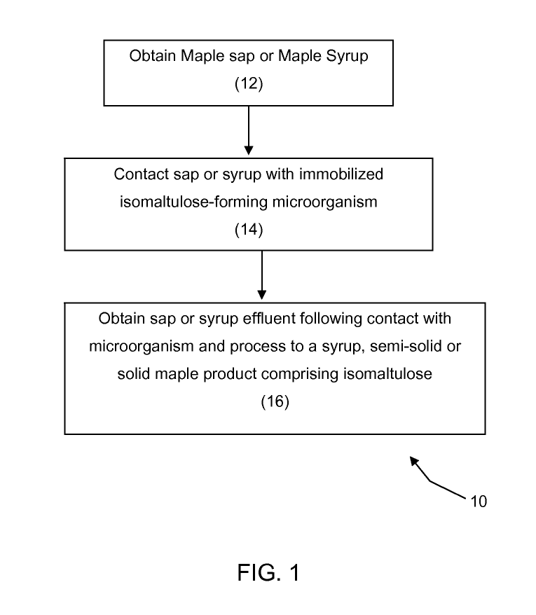

FIG. 1 represents a generalized process scheme (10) according to an exemplary process described herein. Maple syrup or maple sap is obtained (12) and is subsequently contacted (14) with an immobilized isomaltulose-forming microorganism. The sap or syrup effluent so obtained (16) can be used or further processed to a syrup, semi-solid or solid maple product containing isomaltulose having a pre-selected percentage of conversion.

### EXAMPLE 1

Conversion of Maple Sap with Immobilized Erwinia Rhapontici

A solution of maple sap was concentrated by a reverse osmosis process. The sap was obtained from a maple tree, and contained about 8-10% sucrose (w/w) and about 100% of sugars as sucrose. The sap was passed continuously through a column (50 cm×5.5 cm) containing immobilized Erwinia Rhapontici (NCPPB 1578) on calcium alginate at a rate of 780 mL/h at room temperature. The resulting effluent from the column was a solution that contained a sugar content of about 65% sucrose and about 35% isomaltulose, as estimated by HPLC using an analytical column of Prevail Carbohydrate ES and eluted by a solvent system of acetonitrile and water. The theoretical glycemic index of the effluent was about 52.8.

### EXAMPLE 2

Conversion of Maple Sap with Immobilized Erwinia Rhapontici

A solution of maple syrup obtained by concentration of maple sap in a boiler, containing about 25% sucrose (w/w) and about 100% of sugars as sucrose, was passed continuously through a column (50 cm×5.5 cm) containing immobilized Erwinia Rhapontici (NCPPB 1578) on calcium alginate at a rate of 600 mL/h at room temperature. The resulting effluent of the column was a solution containing about 54% of sugars as sucrose and about 46% of sugars as isomaltulose, as estimated by HPLC using an analytical column of Prevail Carbohydrate ES and eluted by a solvent system of acetonitrile and water. The theoretical glycemic index of the effluent was about 49.3.

### EXAMPLE 3

Conversion of Maple Sap with Immobilized Protaminobacter rubrum

A solution of maple syrup obtained by concentration of maple sap in a boiler, containing about 50% sucrose (w/w) and about 100% of sugars as sucrose, was passed continuously through a column (30 cm×1.1 cm) containing immobilized P. rubrum on calcium alginate at a rate of 600 mL/h at room temperature. The resulting effluent of the column was a solution containing about 76% of sugars as sucrose and about 24% of sugars as isomaltulose, as estimated by HPLC using an analytical column of Prevail Carbohydrate ES and eluted by a solvent system of acetonitrile and water. The theoretical glycemic index of the effluent was about 56.3.

### EXAMPLE 4

Conversion of Maple Sap with Immobilized Protaminobacter rubrum

A solution of maple syrup obtained by concentration of maple sap in a boiler, containing about 50% sucrose (w/w) and about 100% of sugars as sucrose, was passed continuously through a column (30 cm×1.1 cm) containing immobilized P. rubrum on calcium alginate at a rate of 300 mL/h at room temperature. The resulting effluent of the column was a solution containing about 54% of sugars as sucrose and about 46% of sugars as isomaltulose, as estimated by HPLC using an analytical column of Prevail Carbohydrate ES and eluted by a solvent system of acetonitrile and water. The theoretical glycemic index of the effluent was about 49.3.

### EXAMPLE 5

Conversion of Maple Sap with Immobilized Protaminobacter rubrum

A solution of maple syrup obtained by concentration of maple sap in a boiler, containing about 50% sucrose (w/w) and about 100% of sugars as sucrose, was passed continuously through a column (30 cm×1.1 cm) containing immobilized P. rubrum on calcium alginate at a rate of 180 mL/h at room temperature. The resulting effluent of the column was a solution containing about 38% of sugars as sucrose and about 62% of sugars as isomaltulose, as estimated by HPLC using an analytical column of Prevail Carbohydrate ES and eluted by a solvent system of acetonitrile and water. The theoretical glycemic index of the effluent was about 44.2.

### EXAMPLE 6

Comparative HPLC Analysis on Maple Sap Samples Before and After Conversion

The samples were prepared following the procedures described by Theriault (Theriault, Caillet, Kermasha and Lacroix, Food Chemistry, 2006, 98, 490-501). For example, 1 L of maple sap solution (50% sugar concentration), with no sucrose to isomaltulose conversion, was adjusted to a pH of 7. The maple sap was extracted four times with ethyl acetate (250 mL×4). The combined ethyl acetate, which contained the extracted phenolic compounds, was washed with 125 mL of water. The ethyl acetate solution was dried using anhydrous sodium sulphate and the filtrate was evaporated under reduced pressure at 40° C. to dryness. Samples of the dried residue were dissolved in 5 mL of methanol and filtered prior to HPLC analysis. 1 L of the maple sap solution (50% sugar concentration, with 45% sucrose converted to isomaltulose), with sucrose to isomaltulose conversion, was treated in the same manner.

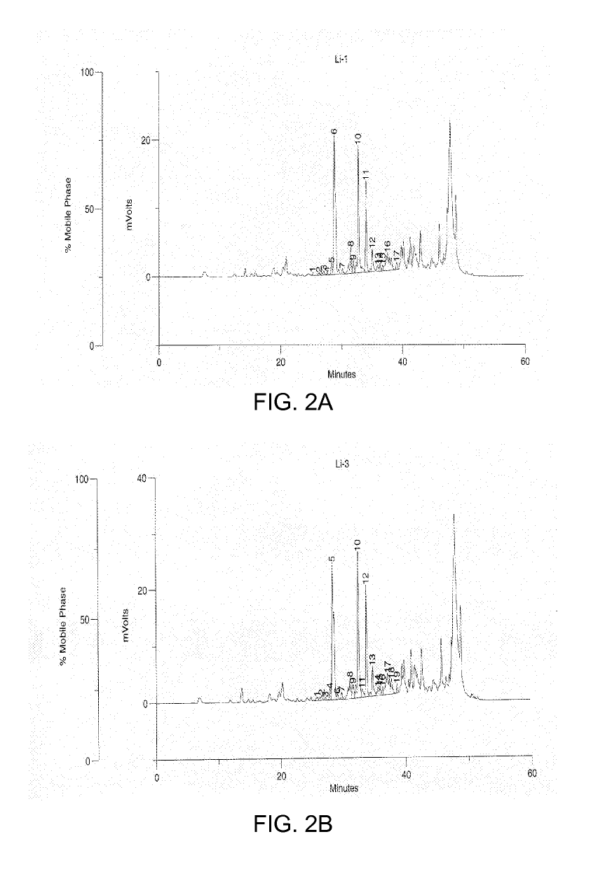

HPLC analysis of the samples was performed on an instrument equipped with a Vydac C18 column (4.6×250 mm). The samples dissolved in methanol (30 μL) were each injected and eluted using a gradient of 6-30% acetonitrile/water containing 0.1% trifluoroacetic acid at a rate of 1 mL/min. The eluent (containing, for example, phenolic compounds) was detected at 214 nm by a UV detector and is illustrated in FIG. 2A (maple sap with no sucrose to isomaltulose conversion) and FIG. 2B (maple sap with sucrose to isomaltulose conversion).

As evidenced by the HPLC traces shown in FIGS. 2A and 2B, the composition of the components detectable at 214 nm (for example the phenolic compounds) are substantially identical, indicating that the process described herein to convert sucrose to isomaltulose does not affect the composition or distribution of the components detectable at 214 nm.

Mineral analysis of magnesium, manganese, potassium, calcium, zinc and iron of maple sap with no sucrose to isomaltulose conversion, and of maple sap with sucrose to isomaltulose conversion, similarly shows that the process described herein to convert sucrose to isomaltulose does not affect the presence of these minerals.

All references noted herein are incorporated by reference in their entirety.

In the preceding description, for purposes of explanation, numerous details are set forth in order to provide a thorough understanding of the embodiments. However, it will be apparent to one skilled in the art that these specific details are not required.

The above-described embodiments are intended to be examples only. Alterations, modifications and variations can be effected to the particular embodiments by those of skill in the art without departing from the scope, which is defined solely by the claims appended hereto.

What is claimed is:

1. A process for the conversion of 20% or more of sucrose in maple sap or maple syrup to isomaltulose comprising contacting the sap or syrup with at least one immobilized isomaltulose-forming microorganism.

2. The process of claim 1, wherein the isomaltulose-forming microorganism is immobilized on a column of calcium alginate.

3. The process of claim 1, wherein said at least one microorganism is Erwinia Rhapontici (NCPPB 1578), Protaminobacter rubrum (CBS 574.77), or a combination thereof.

4. The process of claim 1, wherein said maple sap comprises a sucrose-containing solution from a maple tree.

5. The process of claim 4, wherein the sucrose-containing solution is concentrated by a reverse-osmosis process.

6. The process of claim 1, wherein said maple syrup comprises a concentrated solution from maple sap produced by a boiler, which solution comprises from about 8% to about 50% sucrose.

7. The process of claim 1, wherein the maple sap or maple syrup comprises at least one phenolic compound and the composition of the at least one phenolic compound in the maple sap or maple syrup remains unchanged.

8. The process of claim 1, wherein the maple sap or maple syrup comprises at least one mineral and the composition of the mineral in the maple sap or maple syrup remains unchanged.

9. The process of claim 8, wherein the at least one mineral is magnesium, manganese, potassium, calcium, zinc, iron, or any combination thereof.

10. A product obtained from the process of claim 1.

11. The product of claim 10, comprising an isomaltulose-containing solution from maple sap or maple syrup.

12. The product of claim 10, comprising an isomaltulose-containing sugar syrup concentrated from the isomaltulose-containing solution of claim 11, an isomaltulose-containing semi-solid sugar from the isomaltulose-containing solution of claim 11, or an isomaltulose-containing sugar powder from the isomaltulose-containing solution of claim 11.

13. A product derived from maple syrup or maple sap comprising at least 20 wt % of sugars as isomaltulose.

14. The product of claim 13 wherein the product comprises between 20 wt % and 65 wt % of sugars as isomaltulose.

15. The product of claim 13 further comprising one or more additional sugar.

16. The product of claim 15 wherein the one or more additional sugar is sucrose.

17. The product claim 13 where the product is a solution, a syrup, a semi-solid or a solid.

18. The product of claim 13 further comprising at least one phenolic compound.

19. The product of claim 13 further comprising at least one mineral.

20. The product of claim 19, wherein the at least one mineral is magnesium, manganese, potassium, calcium, zinc, iron, or any combination thereof.
